(19) United States
(12) Patent Application Publication
(10) Pub. No.: US 2007/0073471 A1
(43) Pub. Date: Mar. 29, 2007

(54) Data structure of proceeding control information, data structure of map information, storage medium storing the map information, information generating device, information generating method and navigating device

(75) Inventor: Fusatoshi Abe, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: PIONEER CORPORATION, Tokyo (JP); INCREMENT P CORPORATION, Tokyo (JP)

(21) Appl. No.: 11/474,502

(22) Filed: Jun. 26, 2006

(30) Foreign Application Priority Data
Jun. 27, 2005 (JP) 2005-186340

(51) Int. Cl. G01C 21/00

(52) U.S. Cl. 701/200

(57) ABSTRACT

A traffic-controlled route where a mobile body is prohibited from proceeding to a control end point via a control start point and an intersecting passing point is shown by a traffic control information (510) that has a single data structure in which, for instance, a first node information (512A) defining the control start point, a second node information (512B) defining the intersecting passing point and a third node information (512C) defining the control end point are associated in an order of existence on the traffic-controlled route. Accordingly, a traffic-controlled route in which, for instance, a left turn is prohibited can be shown by the traffic control information (510) including information of points located on this traffic-controlled route, so that a virtual point or route does not have to be newly set. Therefore, the traffic control information (510) capable of showing the traffic control with a simple structure can be provided.

### BACKGROUND OF THE INVENTION

1. Field of the Invention

The present invention relates to a data structure of proceeding control information about a proceeding control at an intersection, a data structure of map information, a storage medium storing the map information, an information generating device, an information generating method and a navigating device.

2. Description of Related Art

There has been conventionally known a navigation device for setting a travel route using map information that has traffic control information about traffic controls such as “no entry” (see, for instance, Document: JP-A-5-107073, right column of page 3 to left column of page 6, FIGS. 4, 6 and 7).

An arrangement disclosed in Document includes a virtual network information storage section for storing road network data. The virtual network information storage section stores a traffic-controlled intersection IV at which a right turn is prohibited for a mobile body proceeding from a link e, the intersection IV being stored as if it is three different intersections IV1, IV2 and IV3. Then, different connection link information is stored for each of nodes of the intersections.

However, since the arrangement as disclosed in Document needs to set a new virtual node for an intersection with a traffic control (e.g., no right turn) and set a new virtual link for the set virtual node, a structure of information about the node or the link might be complicated.

### SUMMARY OF THE INVENTION

An object of the present invention is to provide a data structure of proceeding control information capable of showing a proceeding control with a simple structure, a data structure of map information, a storage medium storing the map information, an information generating device, an information generating method and a navigating device.

According to an aspect of the present invention, a data structure of proceeding control information about a proceeding control at an intersection, the proceeding control being set over a mobile body proceeding from a first route to a second route via the intersection in which a plurality of routes intersect, includes: first point identification information for identifying a predetermined point on the first route; passing point identification information for identifying the intersection; and second point identification information for identifying a predetermined point on the second route, the first point identification information, the passing point identification information and the second point identification information being associated with each other in a predetermined order and constituting a single data structure.

According to another aspect of the present invention, a data structure of proceeding control information showing a proceeding control on map information, the proceeding control being set over a mobile body proceeding from a first route to a second route via a predetermined point, includes: first point identification information for identifying a predetermined point on the first route; passing point identification information for identifying the point that the mobile body passes; and second point identification information for identifying a predetermined point on the second route, the first point identification information, the passing point identification information and the second point identification information being associated in an order in which the mobile body proceeds and constituting a single data structure.

According to still another aspect of the present invention, a data structure of map information includes: route information in which a route and an intersection are defined by a link and a node respectively; and the proceeding control information of the above-described data structure of the present invention, the route information and the proceeding control information constituting a single data structure.

According to yet another aspect of the present invention, a storage medium for storing map information stores the map information of the above-described data structure of the present invention in a manner readable by a computing unit.

According to further aspect of the present invention, an information generating device generates proceeding control information about a proceeding control at an intersection, the proceeding control being set over a mobile body proceeding from a first route to a second route via the intersection in which a plurality of routes intersect, the information generating device recognizing input operation for identifying the first route, the intersection and the second route to generate the proceeding control information of the above-described data structure of the present invention based on the recognized input operation.

According to further aspect of the present invention, an information generating device generates proceeding control information showing a proceeding control on map information, the proceeding control being set over a mobile body proceeding from a first route to a second route via a predetermined point, the information generating device recognizing input operation for identifying the first route, the passed point and the second route to generate the proceeding control information of the above-described data structure of the present invention based on the recognized input operation.

According to further aspect of the present invention, a generating method of proceeding control information about a proceeding control at an intersection, the proceeding control being set over a mobile body proceeding from a first route to a second route via the intersection in which a plurality of routes intersect, includes generating the proceeding control information including: first point identification information for identifying a predetermined point on the first route; passing point identification information for identifying the intersection; and second point identification information for identifying a predetermined point on the second route, the first point identification information, the passing point identification information and the second point identification information being associated with each other in a predetermined order and constituting a single data structure.

According to further aspect of the present invention, a generating method of proceeding control information showing a proceeding control on map information, the proceeding control being set over a mobile body proceeding from a first route to a second route via a predetermined point, includes generating the proceeding control information including: first point identification information for identifying a predetermined point on the first route; passing point identification information for identifying the point the mobile body passes; and second point identification information for identifying a predetermined point on the second route, the first point identification information, the passing point identification information and the second point identification information being associated in an order in which the mobile body proceeds and constituting a single data structure.

According to further aspect of the present invention, a navigating device includes: a current position information acquirer for acquiring current position information about a current position of a mobile body; a destination information acquirer for acquiring destination information about a position of a destination to which the mobile body proceeds; a route information acquirer for acquiring route information in which a route and an intersection are defined by a link and a node respectively; a proceeding control information acquirer for acquiring the proceeding control information of the above-described data structure of the present invention; and a route searcher for searching for a travel route from the current position of the mobile body to the destination based on the current position information, the destination information, the route information and the proceeding control information.

### BRIEF DESCRIPTION OF THE DRAWINGS

FIG. 1 is a block diagram showing an outline of a navigation system according to an embodiment of the present invention;

FIG. 2 is a block diagram showing an outline of a terminal unit according to the embodiment;

FIG. 3 is a block diagram showing an outline of a server unit according to the embodiment;

FIG. 4 is a conceptual diagram schematically showing a table structure of display data of map information according to the embodiment;

FIG. 5 is a conceptual diagram schematically showing a table structure of matching data of the map information according to the embodiment;

FIG. 6 is a schematic diagram showing an outline of a traffic control information database according to the embodiment;

FIG. 7 is a schematic diagram showing a traffic-controlled route shown by traffic control information according to the embodiment;

FIG. 8 is another schematic diagram showing a traffic-controlled route shown by the traffic control information according to the embodiment;

FIG. 9 is still another schematic diagram showing a traffic-controlled route shown by the traffic control information according to the embodiment;

FIG. 10 is yet another schematic diagram showing a traffic-controlled route shown by the traffic control information according to the embodiment; and

FIG. 11 is a flowchart showing search processing of a travel route according to the embodiment.

### DETAILED DESCRIPTION OF PREFERRED EMBODIMENT(S)

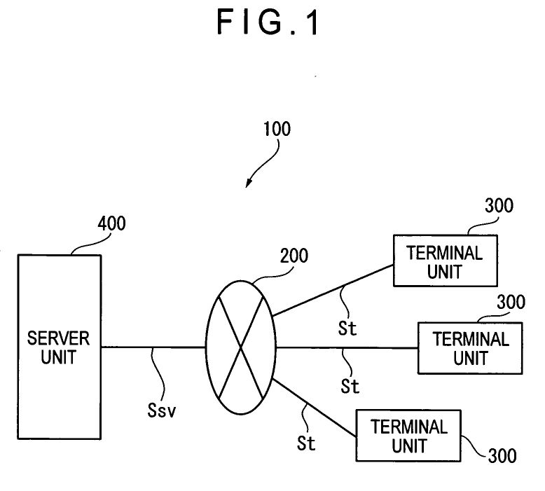

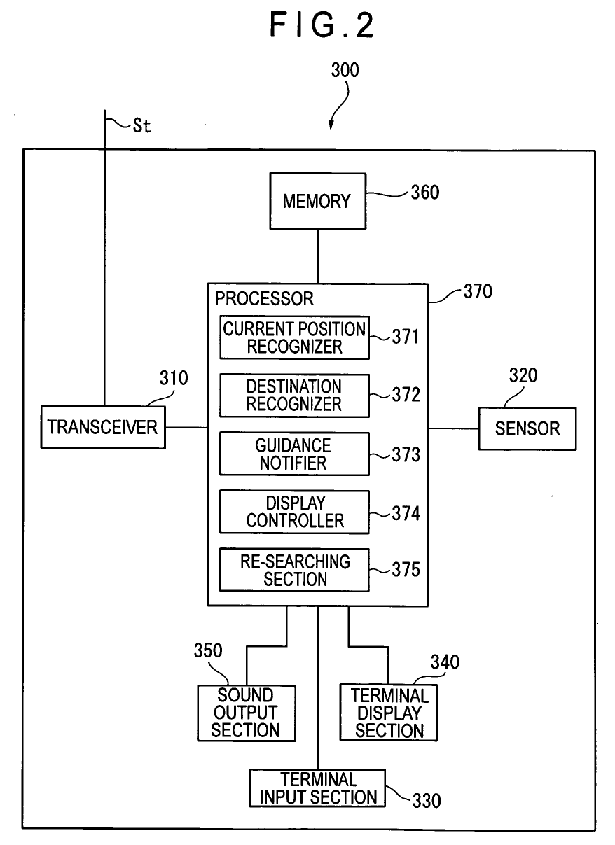

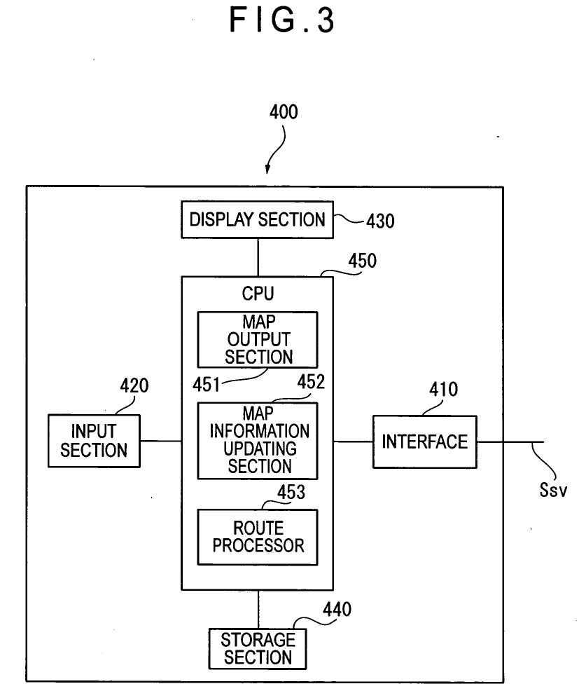

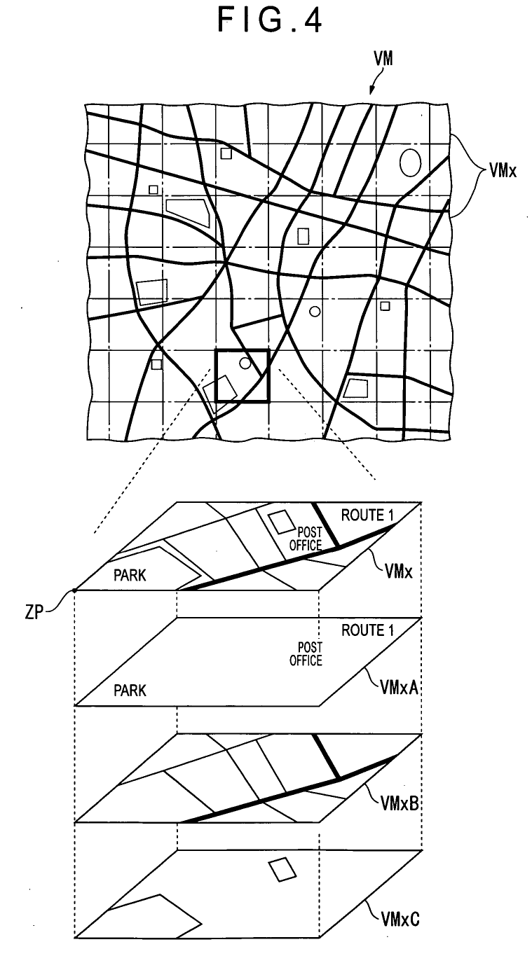

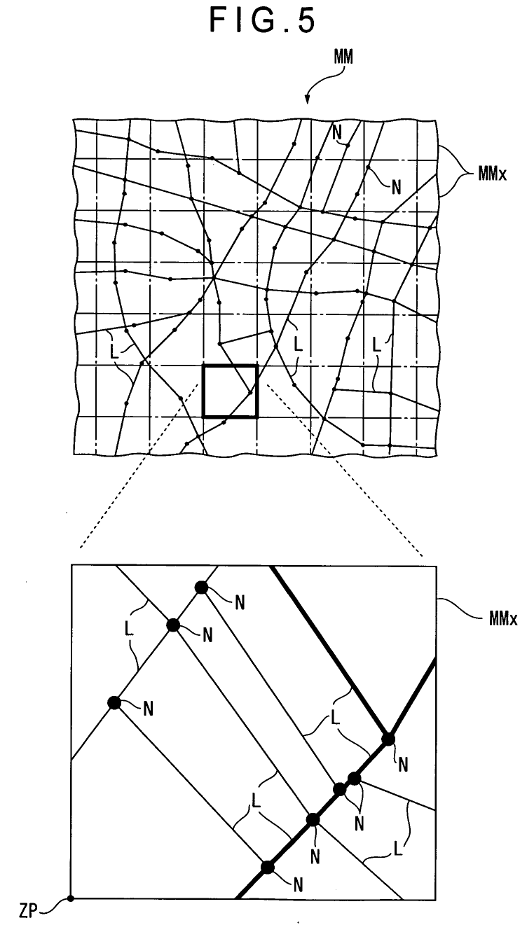

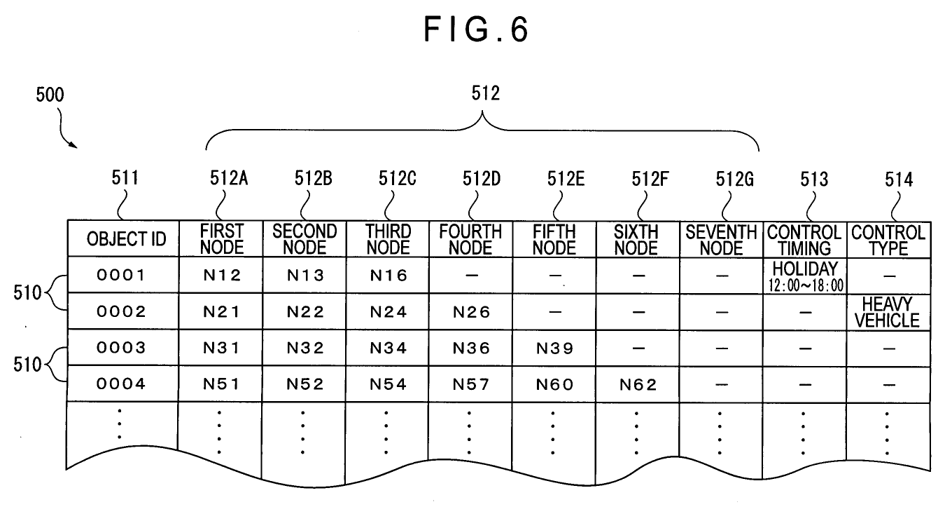

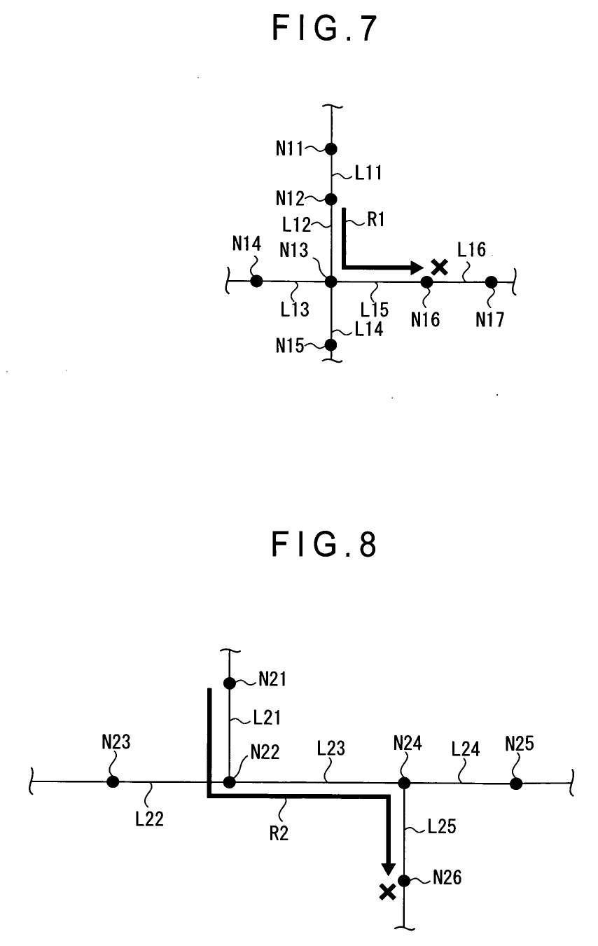

An embodiment of the present invention will be described below with reference to the attached drawings. In this embodiment, the description will be given by exemplifying a communication navigation system (a navigating device) for providing a guidance to a mobile body (e.g., vehicles, aircrafts and ships) along with its travel progress. Note that, in the present invention, an intersection may include a point where routes intersect at a T-shaped intersection or at an expressway ramp. FIG. 1 is a block diagram showing an outline of a navigation system. FIG. 2 is a block diagram showing an outline of a terminal unit. FIG. 3 is a block diagram showing an outline of a server unit. FIG. 4 is a conceptual diagram schematically showing a table structure of display data of map information. FIG. 5 is a conceptual diagram schematically showing a table structure of matching data of map information. FIG. 6 is a schematic illustration showing an outline of a traffic control information database. FIGS. 7 to 10 are schematic diagrams showing a traffic-controlled route shown by traffic control information.

[Arrangement of Navigation System]

In FIG. 1, a reference numeral 100 denotes a communication navigation system. The navigation system 100 provides a guidance to a mobile body (e.g., vehicles, aircrafts and ships) along with its travel progress. The navigation system 100 includes a network 200, a terminal unit 300 and a server unit 400.

The network 200 is connected to the terminal unit 300 and the server unit 400. The network 200 is connected to the terminal unit 300 and the server unit 400 so as to be capable of communicating therewith.

The terminal unit 300 may be an in-vehicle type installed in, for instance, a vehicle as the mobile body, a portable type, a PDA (Personal Digital Assistant), a portable phone, a PHS (Personal Handyphone System), a portable personal computer, etc. The terminal unit 300 acquires map information that is distributed from the server unit 400 via the network 200 in order to search for and display a route to a destination based on the map information. The terminal unit 300 includes, as shown in FIG. 2, a transceiver 310, a sensor 320, a terminal input section 330, a terminal display section 340, a sound output section 350, a memory 360, a processor 370 and the like.

The transceiver 310 is connected to the server unit 400 via the network 200, while being connected to the processor 370. The transceiver 310 can receive a terminal signal St from the server unit 400 via the network 200. The transceiver 310 performs preset input interface processing in response to acquisition of the terminal signal St and outputs the terminal signal St as a processing terminal signal to the processor. The transceiver 310 can also receive the processing terminal signal from the processor 370. The transceiver 310 performs preset output interface processing in response to acquisition of the processing terminal signal and transmits the processing terminal signal as a terminal signal St to the server unit 400 via the network 200. The sensor 320 detects the travel progress of the vehicle, i.e., driving status such as a current position, traveling speed, traveling direction and acceleration and outputs the driving status as a predetermined signal to the processor 370.

The terminal input section 330 includes various operation buttons and operation knobs (each not shown) used for input operation. When settings are input, the terminal input section 330 outputs a predetermined signal to the processor 370 so as to apply the settings. The terminal display section 340, under the control of the processor 370, displays a signal representing image data transmitted from the processor 370. The sound output section 350 has an audio unit such as a speaker (not shown). The sound output section 350, under the control of the processor 370, outputs and notifies various signals as sounds from the audio unit, the various signals representing sound data etc. from the processor 370. The memory 360 appropriately stores various information acquired via the network 200, the settings that are input by the terminal input section 330, music data, image data and the like. The memory 360 also stores various programs that run on an OS (Operating System) controlling the whole operation of the terminal unit 300. The memory 360 may include drives or drivers for readably storing data on a storage medium such as a HD (Hard Disk), a DVD (Digital Versatile Disc) and an optical disc.

The processor 370 has various input/output ports (not shown) including a communication port connected to the transceiver 310, a GPS (Global Positioning Systems) receiving port connected to a GPS receiver, sensor ports respectively connected to various sensors, a key input port connected to the terminal input section 330, a display control port connected to the terminal display section 340, a sound control port connected to the sound output section 350 and a memory port connected to the memory 360. The processor 370 includes, as various programs, a current position recognizer (a current position information acquirer) 371, a destination recognizer (a destination information acquirer) 372, a guidance notifier 373, a display controller 374, a re-searching section 375 and the like.

The current position recognizer 371 recognizes a current position of the vehicle. Specifically, the current position recognizer 371 recognizes the current position based on GPS data about the current position output from the sensor 320 and speed data and azimuth data of the vehicle. The current position recognizer 371 can recognize not only the current position of the vehicle as described above but also a starting point, i.e. an initial point set by the terminal input section 330 as a simulated current position. Various information acquired by the current position recognizer 371 are appropriately stored in the memory 360. The destination recognizer 372 typically acquires destination information about the destination set by the input operation at the terminal input section 330 and recognizes the position of the destination. The destination information to be set includes various information for identifying a spot, which might be coordinates such as latitude and longitude, addresses, telephone numbers and the like. Such destination information recognized by the destination recognizer 372 is appropriately stored in the memory 360.

The guidance notifier 373 provides a guidance stored in the memory 360 in a visual form by using the terminal display section 340 or in an audio form by using the sound output section 350 based on travel route information having been acquired in advance according to the driving status of the vehicle. The guidance is related to the travel of the vehicle, which may be content for assisting the drive of the vehicle. The display controller 374 appropriately controls the terminal display section 340 to display the various information thereon. The display controller 374 also controls display of various display screens for prompting the user to operate the terminal input section 330 so as to set various information. When the current position is deviated from a travel route that has been searched for and acquired in a later-described server unit 400, the re-searching section 375 re-searches for another travel route to the destination using later-described matching mesh information MMx acquired from the server unit 400.

The server unit 400 can transmit/receive information to/from the terminal unit 300 via the network 200. The server unit 400 is capable of acquiring various information from other server units (not shown) installed in various government offices such as Meteorological Agency and National Police Agency, private organizations, VICS (Vehicle Information Communication System (registered trademark)) and business enterprises via the network 200. As shown in FIG. 3, the server unit 400 includes an interface 410, an input section 420, a display section 430, a storage section 440, a CPU (Central Processing Unit) 450 and so on.

The interface 410 performs a preset input interface processing over a server signal Ssv that is input via the network 200 to output the server signal Ssv as a processing server signal to the CPU 450. When the processing server signal to be transmitted to the terminal unit 300 is input in the interface 410 from the CPU 450, the interface 410 performs preset output interface processing over the input processing server signal to output the processing server signal as a server signal Ssv to the terminal unit 300 via the network 200.

The input section 420 has various operation buttons (not shown) used for input operation. When the settings are input, the input section 420 outputs a signal corresponding to the settings to the CPU 450 so as to apply the settings. The display section 430, under the control of the CPU 450, displays a signal representing image data sent from the CPU 450.

The storage section 440 readably stores the various information and the map information received from the terminal unit 300 or an external server unit. The storage section 440 may include a drive or a driver that can readably store data in a storage medium such as an HD (Hard Disk), a DVD (Digital Versatile Disc), an optical disc and a memory card. The map information has a single data structure in which display data VM, which is a so-called POI (Point Of Interest) data as shown in FIG. 4, matching data MM (route information) as shown in FIG. 5, a traffic control information database 500 as shown in FIG. 6 are associated.

The display data VM has plural pieces of display mesh information VMx, each display mesh information having a specific number. To be more specific, the display data VM is divided into plural pieces of display mesh information VMx, each relating to an area. The display data VM is constituted from the plural pieces of display mesh information VMx continuously arranged in a matrix form. The display mesh information VMx may be further divided into plural pieces of display mesh information VMx to be contained in a lower layer, each relating to a smaller area. Each display mesh information VMx has a rectangular shape with each side thereof having a predetermined length, which is reduced relative to an actual geographic length according to a map scale. A predetermined corner thereof contains absolute coordinates ZP in the whole map information, e.g., a global map.

The display mesh information VMx is, for instance, constituted from name information VMxA such as intersection names, road information VMxB and background information VMxC. The name information VMxA has a table data structure for arranging and displaying miscellaneous element data (e.g. intersection name, town name) contained in an area at a predetermined position with reference to the positional relationship based on the absolute coordinates ZP. The road information VMxB has a table data structure for arranging and displaying road element data (e.g. a road) contained in an area at a predetermined position with reference to the positional relationship based on the absolute coordinates ZP. The background information VMxC has a table data structure for arranging and displaying miscellaneous element data (e.g. a mark and image information representing famous spots and buildings) at a predetermined position with reference to the positional relationship based on the absolute coordinates ZP.

The matching data MM, just like the display data VM, is divided into plural pieces of matching mesh information MMx, each having a specific number and relating to an area. The matching data MM is constituted from the plural pieces of matching mesh information MMx continuously arranged in a matrix form. The matching mesh information MMx may be further divided into plural pieces of matching mesh information MMx to be contained in a lower layer, each relating to a smaller area. Each matching mesh information MMx has a rectangular shape with each side thereof having a predetermined length, which is reduced relative to the actual geographic length according to the map scale. A predetermined corner thereof contains absolute coordinates ZP in the whole map information, e.g., a global map. The matching mesh information MMx and the display mesh information VMx may not necessarily represent the same area. That is, they may be divided according to different scales. If the same scale is used, specific number information may be used for associating the data. If different scales are used, the absolute coordinates may be used for associating the data. The matching data MM has plural pieces of link string block information.

As shown in FIG. 5, the link string block information has a table data structure in which a plurality of links L are associated according to a predetermined rule. The link L as segment information represents a road and connects nodes N as the point information. Specifically, the links L each corresponding to a predetermined length of a road are mutually connected to form polygonal lines (i.e. link strings), which represent continuous roads such as Koshu street and Ome street. Each link L has a link ID as a specific number assigned to each link L and node information as a specific number indicating two nodes N connected by the link L.

Each node N represents a joint point such as an intersection, a bend section, a fork, a junction or the like of each road. Information about the node N has a node ID as a specific number assigned to each node N in the link string block information, coordinate information of the position where each node N is located, and flag information as branching information describing whether or not the node N represents a branching position (e.g. intersection, fork) where a plurality of links intersect. Some nodes N only have the node ID and the coordinate information without the flag information for simply representing the shape of a road, and some nodes N additionally have attribute information representing the road structure such as width of a tunnel or a road.

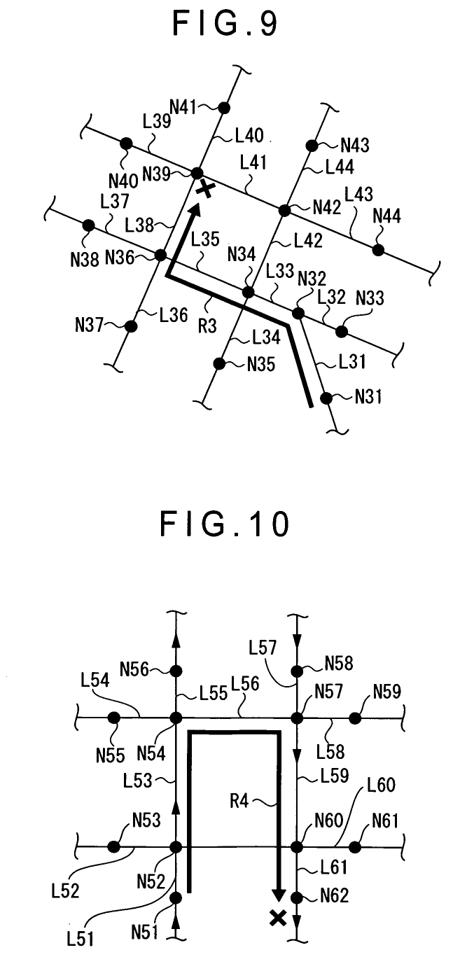

The traffic control information database 500 is a database of information about a traffic-controlled route Ra (a represents a natural number) in which the vehicle is prohibited only from proceeding to a control end point (second point) via a control start point (first point) and at least one of an intersection, a fork and a junction at which a plurality of roads intersect (hereinafter, referred to as an intersecting passing point), namely a database of information about a traffic-controlled route Ra in which, for instance, a left turn or a U-turn is prohibited. The traffic-controlled route Ra included in the traffic control information database 500 is recognized as an unsettable route in search processing of a travel route by the server unit 400. For example, a traffic-controlled route R1 defined by links L12 and L15 where the vehicle is prohibited from proceeding to a node N16 via nodes N12 and N13 as shown in FIG. 7 and a traffic-controlled route R2 defined by links L21, L23 and L25 where the vehicle is prohibited from proceeding to a node N26 via nodes N21, N22 and N24 in sequence as shown in FIG. 8 are both recognized as unsettable travel routes. Likewise, a traffic-controlled route R3 defined by links L31, L33, L35 and L38 where the vehicle is prohibited from proceeding to a node N39 via nodes N31, N32, N34 and N36 in sequence as shown in FIG. 9 and a traffic-controlled route R4 defined by links L51, L53, L56, L59 and L61 where the vehicle is prohibited from proceeding to a node N62 via nodes N51, N52, N54, N57 and N60 in sequence as shown in FIG. 10 are both recognized as unsettable travel routes. Note that a travel route that includes only a part of the traffic-controlled route Ra is recognized as a settable travel route. For example, a route defined by links L14 and L15 where the vehicle proceeds to a node N16 via nodes N15 and N13 as shown in FIG. 7 and a route defined by links L31, L33 and L34 where the vehicle proceeds to a node N35 via nodes N31, N32 and N34 in sequence as shown in FIG. 9 are both recognized as settable travel routes. In the examples, the routes defined by the links L12, L21, L31 and L51 each correspond to a first route of the present invention. Also, the routes defined by the links L15, L25, L38 and L61 each correspond to a second route of the present invention.

The traffic control information database 500 includes at least a piece of traffic control information (proceeding control information) 510 as a single data structure as shown in FIG. 6.

The traffic control information 510 is information about one traffic-controlled route Ra. The traffic control information 510 is used for recognizing a traffic-controlled route Ra that is unsettable as a travel route in the search processing of a travel route by the server unit 400. The traffic control information 510 includes object ID information 511, controlled route node information 512, control timing information 513 and control type information 514.

The object ID information 511 is specific information for identifying the traffic control information 510. The object ID information 511 contains information indicated by a number or an alphabet.

The controlled route node information 512 is information about a node N defining a control start point, an intersecting passing point and a control end point that identify a traffic-controlled route Ra. The controlled route node information 512 includes first node information 512A, second node information 512B, third node information 512C, fourth node information 512D, fifth node information 512E, sixth node information 512F and seventh node information 512G.

Note that it has been verified that almost all existing traffic-controlled routes Ra can be shown by identifying node N of the number from three to seven, namely by identifying nodes N defining intersecting passing points of the number from one to five. This is why the controlled route node information 512 is constituted by the first to seventh node information 512A to 512G as described above. Incidentally, the first node information 512A serves as first node specific information, which is first point identification information of the present invention. The second node information 512B serves as passing node specific information, which is passing point identification information of the present invention. The third to sixth node information 512C to 512F serve as second end node specific information (passing node specific information or second point identification information), which is passing point identification information of the present invention. The seventh node information 512G serves as second end node specific information, which is second point identification information of the present invention.

The first node information 512A is information for identifying a node N of a control start point of a traffic-controlled route Ra. Specifically, when the traffic-controlled routes R1 to R4 are set, the first node information 512A contains node IDs of the nodes N12, N21, N31 and N51 that define the control start points.

The second node information 512B is information for identifying a node N of an intersecting passing point that is located adjacent to the node N identified by the first node information 512A in a direction to which the vehicle is prohibited from proceeding. Specifically, when the traffic-controlled routes R1 to R4 are set, the second node information 512B contains node IDs of the nodes N13, N22, N32 and N52 that define the intersecting passing points.

The third node information 512C is information for identifying a node N of an intersecting passing point or a control end point that is located adjacent to the node N identified by the second node information 512B in the direction to which the vehicle is prohibited from proceeding. Specifically, when a traffic-controlled route Ra identified by three nodes N is set, namely when the traffic-controlled route R1 is set, the third node information 512C contains a node ID of the node N16 that defines the control end point. When a traffic-controlled route Ra identified by four or more nodes N is set, namely when the traffic-controlled routes R2 to R4 are set, the third node information 512C contains node IDs of the nodes N24, N34 and N54 that define the intersecting passing points.

The fourth node information 512D is information for identifying a node N of an intersecting passing point or a control end point that is located adjacent to the node N identified by the third node information 512C in the direction to which the vehicle is prohibited from proceeding. Specifically, when a traffic-controlled route Ra identified by four nodes N is set, namely when the traffic-controlled route R2 is set, the fourth node information 512D contains a node ID of the node N26 that defines the control end point. When a traffic-controlled route Ra identified by five or more nodes N is set, namely when the traffic-controlled routes R3 and R4 are set, the fourth node information 512D contains node IDs of the nodes N36 and N57 that define the intersecting passing points.

The fifth node information 512E is information for identifying a node N of an intersecting passing point or a control end point that is located adjacent to the node N identified by the fourth node information 512D in the direction to which the vehicle is prohibited from proceeding. Specifically, when a traffic-controlled route Ra identified by five nodes N is set, namely when the traffic-controlled route R3 is set, the fifth node information 512E contains a node ID of the node N39 that defines the control end point. When a traffic-controlled route Ra identified by six or more nodes N is set, namely when the traffic-controlled route R4 is set, the fifth node information 512E contains a node ID of the node N60 that defines the intersecting passing point.

The sixth node information 512F is information for identifying a node N of an intersecting passing point or a control end point that is located adjacent to the node N identified by the fifth node information 512E in the direction to which the vehicle is prohibited from proceeding. Specifically, when a traffic-controlled route Ra identified by six nodes N is set, namely when the traffic-controlled route R4 is set, the sixth node information 512F contains a node ID of the node N62 that defines the control end point. When a traffic-controlled route Ra defined by seven nodes N is set, the sixth node information 512F contains a node ID of a node N that defines an intersecting passing point.

The seventh node information 512G is information for identifying a node N at a control end point. Specifically, when a traffic-controlled route Ra identified by seven nodes N is set, the seventh node information 512G contains the node ID of the node N that defines the control end point.

The control timing information 513 is information about a timing when a traffic control is performed in the traffic-controlled route Ra. Specifically, when the traffic control is performed only at a specific timing, the control timing information 513 records information about a date, a day of the week, time or the like that indicate the timing. On the other hand, when the traffic control is performed year round, no information is recorded in the control timing information 513. Incidentally, in the case where the traffic control is performed year round, the information indicating accordingly may alternatively be recorded.

The control type information 514 is information about a type of vehicle that is subjected to the traffic control in the traffic-controlled route Ra. Specifically, when the traffic control is performed only against a predetermined vehicle, the control type information 514 records information about the vehicle type (e.g., a heavy vehicle, a bus and a two-wheeled motor vehicle). On the other hand, when the traffic control is performed against all types of vehicles, no information is recorded in the control type information 514. Incidentally, in the case where the traffic control is performed against all types of vehicles, the information may alternatively be recorded.

The storage section 440 also stores information such as various programs that run on an OS controlling the whole operation of the server unit 400 and the navigation system 100. The storage section 440 stores personal information about a user who uses the navigation system 100 with the terminal unit 300.

The CPU 450 includes, as various programs stored in the storage section 440, a map output section 451, a map information updating section 452 also functioning as an information generating device and a route processor (route searcher) 453 also functioning as a route information acquirer and a proceeding control information acquirer.

The map output section 451 responds to the input processing server signal to refer to information for requesting distribution of the information about the map information contained in the processing server signal, and reads out as a memory signal the requested information in the map information stored in the storage section 440, e.g., the display data VM and the matching data MM corresponding to a predetermined area. The map output section 451 then converts the read memory signal into a processing server signal, outputs the processing server signal to predetermined or all terminal units 300 via the interface 410 and the network 200 on the basis of the processing server signal, and distributes the requested information contained in the map information.

The map information updating section 452 performs update processing of the map information based on the input operation at the input section 420. Specifically, when, for instance, a signal for requesting update of information about the display data VM, the matching data MM, the link L or the node N is input from the input section 420, the map information updating section 452 performs the update processing.

When acquiring a signal for requesting generation of the traffic control information 510 from the input section 420, the map information updating section 452 displays a predetermined map on the display section 430 based on the map information. Then, for instance, when acquiring a signal indicating that predetermined points that identify a traffic-controlled route Ra on the map are sequentially selected, the map information updating section 452 generates the controlled route node information 512 containing the first to seventh node information 512A to 512G containing node ID of nodes N defining the selected points. Incidentally, the map information updating section 452 may generate the controlled route node information 512 based on a signal indicating that a node ID of a node N is directly input without displaying the map. The order for selecting the predetermined points of the traffic-controlled route Ra is not limited to the order starting from the control start point to the intersecting passing point and the control end point, but may be an order, for instance, starting from the control start point to the control end point and the intersecting passing point.

The map information updating section 452 displays an instruction for prompting the user to input information about the timing for performing the traffic control or the type of vehicle subjected to the traffic control on the display section 430. When receiving a signal for identifying the timing or the type of vehicle subjected to the traffic control from the input section 420, the map information updating section 452 generates the control timing information 513 or the control type information 514 which contains the identified content. Further, the map information updating section 452 generates the object ID information 511 containing the specific object ID. Then, the map information updating section 452 generates the traffic control information 510 that has a single data structure including the generated object ID information 511, controlled route node information 512, control timing information 513 and control type information 514, and incorporates the traffic control information 510 in the traffic control information database 500.

When acquiring from the input section 420 a signal for changing content of predetermined traffic control information 510 or a signal for deleting predetermined traffic control information 510, the map information updating section 452 performs processing in accordance with the received signal.

The route processor 453 responds to the input processing server signal and refers to information about a search request for a route contained in the processing server signal to compute and search for a travel route using the map information stored in the storage section 440, and generates a memory signal. The route processor 453 then converts the generated memory signal into a processing server signal and outputs the processing server signal to a predetermined terminal unit 300 via the interface 410 and the network 200 to notify the travel route.

Specifically, the route processor 453 acquires from the terminal unit 300 the current position information, the destination information and setting information for route setting. Then, based on the acquired information, the route processor 453 utilizes the map information to set a travel route so as to avoid a traffic-controlled route Ra shown by the traffic control information 510 and generates travel route information as a memory signal. The travel route information typically includes route guidance information for navigating the vehicle during the drive thereof for assisting the drive. The route guidance information is appropriately displayed or output with sound at the terminal unit 300 to assist the drive.

[Operation of Navigation System]

Now, the operation of the navigation system 100 will be described with reference to the drawings.

(Generation Processing of Traffic Control Information)

First, generation processing of the traffic control information 510 will be described as an operation of the navigation system 100. Note that the generation processing of the traffic control information 510 of the traffic-controlled route R1 will be exemplified for the description.

When the map information updating section 452 recognizes that a setting for generating the traffic control information 510 is input by an operator of the server unit 400, the server unit 400 of the navigation system 100 displays, for instance, a road map defined by the links L11 to L16 and the nodes N11 to N17 as shown in FIG. 7 on the display section 430. Then, when recognizing a setting that indicates points corresponding to the nodes N12, N13 and N16 identifying the traffic-controlled route R1 are sequentially selected, the map information updating section 452 generates the controlled route node information 512 having the first to third node information 512A to 512C respectively containing the node IDs of the nodes N12, N13 and N16.

Thereafter, the map information updating section 452 displays an instruction on the display section 430 for prompting the operator to input the timing of the traffic control and the type of vehicle subjected to the traffic control. When recognizing the setting indicating that the timing of the traffic control is from noon to 6:00 pm of holidays, the map information updating section 452 generates the control timing information 513 containing such information. When recognizing the setting indicating that a type of vehicle subjected to the traffic control is not specified, the map information updating section 452 generates the control type information 514 containing no information. Further, the map information updating section 452 generates the object ID information 511 containing an object ID of “0001”. Then, the map information updating section 452 generates the traffic control information 510 including the generated object ID information 511, controlled route node information 512, control timing information 513 and control type information 514, and incorporates the traffic control information 510 in the traffic control information database 500.

(Search Processing of Travel Route)

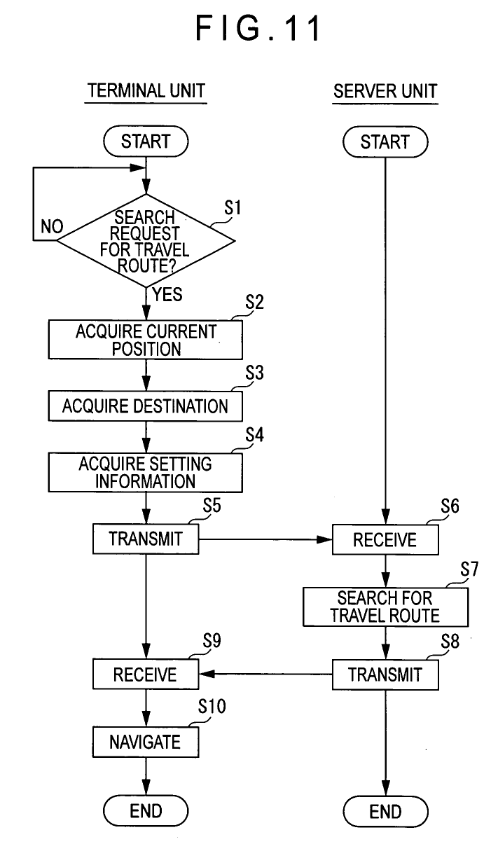

Next, search processing of a travel route will be described as an operation of the navigation system 100. FIG. 11 is a flowchart showing the search processing of the travel route.

First, as shown in FIG. 11, the user of the navigation system 100 operates the terminal input section 330 to input a setting for performing search processing of a travel route. When the processor 370 recognizes the setting for performing the search processing of the travel route (Step S1), the processor 370 recognizes the current position with the current position recognizer 371 (Step S2), while recognizing the set destination with the destination recognizer 372 (Step S3). The processor 370 also acquires the setting information about the settings that have been input by the input operation at the terminal input section 330 (Step S4). Thereafter, the processor 370 controls the transceiver 310 to transmit the current position information, the destination information and the setting information as well as a signal requesting the travel route search to the server unit 400 (Step S5).

The server unit 400 then acquires the current position information, the destination information and the setting information as well as the signal for requesting the travel route search (Step S6), and operates the route processor 453 to perform the search processing of a travel route by avoiding the traffic-controller route Ra from the current position of the vehicle to the destination. Thereafter, the server unit 400 generates travel route information about some travel routes that meet requirements of the user (Step S7). Then, the server unit 400 controls the interface 410 to transmit the travel route information obtained by the search processing as well as the map information to a terminal unit 300 that has requested the travel route search (Step S8).

Thereafter, the processor 370 of the terminal unit 300 acquires the travel route information (Step S9) and controls the terminal display section 340 to display the travel route in a manner superimposing on the acquired map information. The processor 370 then recognizes the travel progress of the vehicle based on the data output from the speed sensor, the azimuth sensor and the acceleration sensor of the sensor 320 and the GPS data output from the GPS receiver. Further, the guidance notifier 373 of the processor 370 notifies guidance information for navigating the travel of the vehicle in visual or audio form on the basis of the recognized travel progress and route guidance information contained in the travel route information acquired from the server unit 400 (Step S110).

[Advantage of Navigation System]

As described above, in the embodiment described above, the traffic-controlled route Ra where the vehicle is prohibited from proceeding into the control end point via the control start point and at least one intersecting passing point at which a plurality of roads intersect is shown by the traffic control information 510 that has a single data structure in which, for instance, the first node information 512A defining the control start point, the second node information 512B defining the intersecting passing point and the third node information 512C defining the control end point are associated in a predetermined order. Accordingly, the traffic-controlled route R1 in which, for instance, a left turn is prohibited, can be shown by the traffic control information 510 including information of points located on the traffic-controlled route R1, so that, unlike conventional arrangements, a virtual point or a virtual route does not have to be newly set. Therefore, the traffic control information 510 capable of showing the traffic control with a simple structure can be provided. In the arrangement of the present embodiment, since information about the links L and the nodes N are not changed, such information are not affected. The traffic control information 510 can be generated only by sequentially setting the points on the traffic-controlled route Ra, thereby simplifying generation processing of the traffic control information 510. Also the traffic-controlled route Ra in which a U-turn is prohibited is shown by the traffic control information 510, thereby enhancing user-friendliness.

For example, the first node information 512A, the second node information 512B and the third node information 512C are associated in the order of existence of the points located on the traffic-controlled route Ra. Thus, for instance, the first node information 512A, the second node information 512B and the third node information 512C can be associated by an order set by the input operation, so that load in generation processing can be reduced as compared to an arrangement for associating the node information in an order different from the input order.

The first to seventh node information 512A to 512G contain the node IDs of the nodes N defining the control start point, the intersecting passing point and the control end point. Thus, information amount of the traffic-control information 510 can be reduced as compared to an arrangement that contains, for instance, latitudes and longitudes or addresses of the points.

In the above embodiment, since the first to seventh node information 512A to 512G are contained in the traffic control information 510, the traffic-controlled route Ra identified by nodes N of the number from three to seven can be shown, namely the traffic-controlled route Ra identified by nodes N of the number from one to five that define the intersecting passing points. Thus, almost all the existing traffic-controlled routes Ra can be shown with minimum information amount, thereby further enhancing the usefulness of the traffic control information 510.

The traffic control information 510 includes the control timing information 513 about the timing when the traffic control is performed. Thus, the timing when the traffic control is performed can be shown in addition to the traffic-controlled route Ra, so that the traffic control information 510 can show more details. Therefore, the usefulness of the traffic control information 510 can further be enhanced.

The traffic control information 510 includes the control type information 514 about the type of vehicle subjected to the traffic control. Thus, the type of vehicle subjected to the traffic control can be shown in addition to the traffic-controlled route Ra, so that the traffic control information 510 can show more details. Therefore, the usefulness of the traffic control information 510 can further be enhanced.

The map information includes the display data VM, the matching data MM and the traffic control information database 500. By storing the map information in the storage section 440 of the server unit 400, the route processor 453 can set the travel route so as to avoid the traffic-controlled route Ra. Thus, the server unit 400 can appropriately set the travel route using the map information with a simple structure, thereby reducing processing load.

Since the server unit 400 of the navigation system 100 sets the travel route from the current position recognized by the terminal unit 300 to the destination so as to avoid the traffic-controlled route Ra based on the map information including the traffic control information 510 capable of showing the traffic control with the simple structure. Thus, the navigation system 100 can appropriately set the travel route with simple processing. Even when recognizing requests for setting travel routes from a plurality of terminal units 300 substantially coincidentally, the navigation system 100 can respond to the requests promptly.

When, for instance, recognizing the setting that indicates the points corresponding to the nodes N12, N13 and N16 identifying the traffic-controlled route R1 are sequentially selected, the map information updating section 452 generates the controlled route node information 512 having the first to third node information 512A to 512C respectively containing the node IDs of the nodes N12, N13 and N16. Therefore, the map information updating section 452 that generates the traffic control information 510 capable of showing the traffic control with the simple structure can be provided.

Since the map information updating section 452 is realized as, for instance, a program, the traffic control information 510 capable of showing the traffic control with the simple structure by installing the program, which allows expansion of utilization.

The proceeding control information of the present invention is applied to the traffic control information 510 for showing the traffic-controlled route Ra of the vehicle. Therefore, as compared to a case for applying it to ships or aircraft, the expansion of utilization can be realized easily.

[Modification of Embodiment]

The present invention is not limited to the above specific embodiments, but includes modifications and improvements as long as the objects of the present invention can be attained.

Although, the above embodiment exemplifies an arrangement for generating the traffic control information 510 about the traffic-controlled route Ra in which the vehicle is prohibited from proceeding to the control end point via the control start point and a point at which a plurality of roads intersect, there may be employed an arrangement for generating traffic control information 510 about a traffic-controlled route Ra in which the vehicle is prohibited from making a U-turn to enter an oncoming lane at a point other than intersections or for generating traffic control information 510 about a traffic-controlled route Ra that does not include an intersection to which the vehicle is prohibited from proceeding. As an example, when recognizing a setting that indicates that a control start point, a bend section corresponding to a point where the U-turn is prohibited and a control end point are sequentially selected, the map information updating section 452 may generate traffic control information 510 in which first node information 512A containing a node ID of the control start point, second node information 512B containing a node ID of the bend section corresponding to the point where the U-turn is prohibited and third node information 512C containing a node ID of the control end point are associated in an order of existence of the points on the traffic-controlled route Ra. Such arrangement can provide the traffic control information 510 capable of showing, with a simple structure, that the U-turn to the oncoming lane is prohibited at the point other than intersections.

As another example, the first node information 512A defining the control start point, the second node information 512B defining the intersecting passing point, the third node information 512C defining the control end point may be associated in an order starting from the control start point to the control end point and the intersecting passing point. As still another example, information containing a latitude and a longitude or an address of each point may be employed in place of the first to seventh node information 512A to 512G. These arrangements can also show the traffic control with simple structures without newly setting a virtual point or the like, unlike conventional arrangements.

As yet another example, the traffic control information 510 may not include at least any one of the fourth to seventh node information 512D to 512G. As further example, the traffic control information 510 may not include at least one of the control timing information 513 and the control type information 514. With these arrangements, information amount of the traffic control information 510 can be reduced, thus simplifying the arrangement of the traffic control information 510.

As further example, the traffic control information 510 may further include eighth and ninth node information so as to be capable of showing a traffic-controlled route Ra that is identified by six or more nodes N defining intersecting passing points. With the arrangement, the traffic-controlled route Ra can be shown even when changes such as increase of controlled points and the like are made, thereby enhancing its usefulness.

The proceeding control information of the present invention may be applied to an arrangement for showing a proceeding control of a ship or an aircraft. The map information may be stored in a storage medium such that its utilization can be easily expanded by distributing the storage medium. A dedicated traffic control information generating device with an independent function for generating the traffic control information 510 in the map information updating section 452 may be provided. The map information may be stored in a storage section of a navigation device that does not have a communicating function so that a travel route avoiding a traffic-controlled route Ra is set by the navigation device.

A program for operating the map information updating section 452 to perform processing may be stored in a storage medium in a manner readable by a computing unit, i.e., a computer. With this arrangement, an arrangement for generating the traffic control information 510 capable of showing a traffic control with a simple structure can be provided, and the program can be handled easily, thereby easily expanding the utilization. The computing unit may not necessarily be a single computer but may be a plurality of computers connected over a network, elements such as a CPU and a microcomputer, or a circuit board on which a plurality of electronic parts are mounted.

The arrangements and the operating procedures for the present invention may be appropriately modified as long as the scope of the present invention can be attained.

[Advantages of Embodiment]

In the embodiment described above, the traffic-controlled route Ra where the vehicle is prohibited from proceeding into the control end point via the control start point and the intersecting passing point is shown by the traffic control information 510 that has a single data structure in which, for instance, the first node information 512A defining the control start point, the second node information 512B defining the intersecting passing point and the third node information 512C defining the control end point are associated in a predetermined order. Accordingly, the traffic-controlled route R1 in which, for instance, a left turn is prohibited, can be shown by the traffic control information 510 including information of points located on the traffic-controlled route R1, so that, unlike conventional arrangements, a virtual point or route does not have to be newly set. Therefore, the traffic control information 510 capable of showing the traffic control with a simple structure can be provided.

The traffic-controlled route Ra in which, for instance, a U-turn to the oncoming lane is prohibited at the point other than the intersections is shown by the traffic control information 510 having a single data structure in which the first node information 512A defining the control start point, the second node information 512B defining the bend section corresponding to the point where the U-turn is prohibited and the third node information 512C defining the control end point are associated in the order of existence of the points on the traffic-controlled route Ra. Thus, the traffic control information 510 capable of showing, with a simple structure, that the U-turn to the oncoming lane is prohibited at the point other than intersections can be provided.

When, for instance, recognizing a setting that indicates the points corresponding to the nodes N12, N13 and N16 identifying the traffic-controlled route R1 are sequentially selected, the map information updating section 452 generates the controlled route node information 512 having the first to third node information 512A to 512C containing the node IDs of the nodes N12, N13 and N16. Therefore, the map information updating section 452 that generates the traffic control information 510 capable of showing the traffic control with a simple structure can be provided.

When, for instance, recognizing the setting that indicates that the control start point, the bend section corresponding to the point where the U-turn is prohibited and the control end point are sequentially selected, the map information updating section 452 generates traffic control information 510 in which the first node information 512A containing the node ID of the control start point, the second node information 512B containing the node ID of the bend section corresponding to the point where the U-turn is prohibited and the third node information 512C containing the node ID of the control end point are associated in the order of existence of the points on the traffic-controlled route Ra. Therefore, the map information updating section 452 that generates the traffic control information 510 capable of showing the traffic control with a simple structure can be provided.

Since the server unit 400 of the navigation system 100 sets the travel route from the current position recognized by the terminal unit 300 to the destination so as to avoid the traffic-controlled route Ra based on the map information including the traffic control information 510 capable of showing the traffic controls with a simple structure. Thus, the navigation system 100 can appropriately set the travel route with simple processing.

The priority application Number JP2005-186340 upon which this patent application is based is hereby incorporated by reference.

What is claimed is:

1. A data structure of proceeding control information about a proceeding control at an intersection, the proceeding control being set over a mobile body proceeding from a first route to a second route via the intersection in which a plurality of routes intersect, the data structure comprising:
first point identification information for identifying a predetermined point on the first route;
passing point identification information for identifying the intersection; and
second point identification information for identifying a predetermined point on the second route, the first point identification information, the passing point identification information and the second point identification information being associated with each other in a predetermined order and constituting a single data structure.

2. The data structure of the proceeding control information according to claim 1, wherein the predetermined order is an order in which the mobile body proceeds from the first route to the second route.

3. The data structure of the proceeding control information according to claim 1, wherein
the point and the intersection each are indicated as a node,
the first point identification information is first node specific information that is specific to a node defining the predetermined point on the first route,
the passing point identification information is passing node specific information that is specific to a node defining the intersection, and
the second point identification information is second node specific information that is specific to a node defining the predetermined point on the second route.

4. The data structure of the proceeding control information according to claim 1, wherein the number of the intersections that the mobile body passes is five or smaller.

5. A data structure of proceeding control information showing a proceeding control on map information, the proceeding control being set over a mobile body proceeding from a first route to a second route via a predetermined point, the data structure comprising:
first point identification information for identifying a predetermined point on the first route;
passing point identification information for identifying the point that the mobile body passes; and
second point identification information for identifying a predetermined point on the second route, the first point identification information, the passing point identification information and the second point identification information being associated in an order in which the mobile body proceeds and constituting a single data structure.

6. The data structure of the proceeding control information according to claim 5, wherein
the point is indicated as a node,
the first point identification information is first node specific information that is specific to a node defining a predetermined point on the first route,
the passing point identification information is passing node specific information that is specific to a node defining the point that the mobile body passes, and
the second point identification information is second node specific information that is specific to a node defining a predetermined point on the second route.

7. The data structure of the proceeding control information according to claim 1, further comprising:
control timing information about a timing when the proceeding control is performed.

8. The data structure of the proceeding control information according to claim 5, further comprising:
control timing information about a timing when the proceeding control is performed.

9. The data structure of the proceeding control information according to claim 1, further comprising:
control type information about a type of a mobile body that is subjected to the proceeding control.

10. The data structure of the proceeding control information according to claim 5, further comprising:
control type information about a type of a mobile body that is subjected to the proceeding control.

11. A data structure of map information, comprising
route information in which a route and an intersection are defined by a link and a node respectively; and
proceeding control information about a proceeding control at an intersection, the proceeding control being set over a mobile body proceeding from a first route to a second route via the intersection in which a plurality of routes intersect, the route information and the proceeding control information constituting a single data structure, wherein
a data structure of the proceeding control information includes:
first point identification information for identifying a predetermined point on the first route;
passing point identification information for identifying the intersection; and
second point identification information for identifying a predetermined point on the second route, the first point identification information, the passing point identification information and the second point identification information being associated with each other in a predetermined order and constituting a single data structure.

12. A data structure of map information, comprising
route information in which a route and an intersection are defined by a link and a node respectively; and
proceeding control information showing a proceeding control on map information, the proceeding control being set over a mobile body proceeding from a first route to a second route via a predetermined point, the route information and the proceeding control information constituting a single data structure, wherein
a data structure of the proceeding control information includes:
first point identification information for identifying a predetermined point on the first route;
passing point identification information for identifying the point that the mobile body passes; and
second point identification information for identifying a predetermined point on the second route, the first point identification information, the passing point identification information and the second point identification information being associated in an order in which the mobile body proceeds and constituting a single data structure.

13. A storage medium storing map information in a manner readable by a computing unit, wherein
a data structure of the map information includes:
route information in which a route and an intersection are defined by a link and a node respectively; and
proceeding control information about a proceeding control at an intersection, the proceeding control being set over a mobile body proceeding from a first route to a second route via the intersection in which a plurality of routes intersect, the route information and the proceeding control information constituting a single data structure, and
a data structure of the proceeding control information includes:
first point identification information for identifying a predetermined point on the first route;
passing point identification information for identifying the intersection; and
second point identification information for identifying a predetermined point on the second route, the first point identification information, the passing point identification information and the second point identification information being associated with each other in a predetermined order and constituting a single data structure.

14. A storage medium storing map information in a manner readable by a computing unit, wherein
a data structure of the map information includes:
route information in which a route and an intersection are defined by a link and a node respectively; and
proceeding control information showing a proceeding control on map information, the proceeding control being set over a mobile body proceeding from a first route to a second route via a predetermined point, the route information and the proceeding control information constituting a single data structure, wherein
a data structure of the proceeding control information includes:
first point identification information for identifying a predetermined point on the first route;
passing point identification information for identifying the point that the mobile body passes; and
second point identification information for identifying a predetermined point on the second route, the first point identification information, the passing point identification information and the second point identification information being associated in an order in which the mobile body proceeds and constituting a single data structure.

15. An information generating device for generating proceeding control information about a proceeding control at an intersection, the proceeding control being set over a mobile body proceeding from a first route to a second route via the intersection in which a plurality of routes intersect, wherein
the information generating device recognizes input operation for identifying the first route, the intersection and the second route to generate the proceeding control information based on the recognized input operation, and
a data structure of the proceeding control information includes:
first point identification information for identifying a predetermined point on the first route;
passing point identification information for identifying the intersection; and
second point identification information for identifying a predetermined point on the second route, the first point identification information, the passing point identification information and the second point identification information being associated with each other in a predetermined order and constituting a single data structure.

16. An information generating device for generating proceeding control information showing a proceeding control on map information, the proceeding control being set over a mobile body proceeding from a first route to a second route via a predetermined point, wherein
the information generating device recognizes input operation for identifying the first route, the passed point and the second route to generate the proceeding control information based on the recognized input operation, and
a data structure of the proceeding control information includes:
first point identification information for identifying a predetermined point on the first route;
passing point identification information for identifying the point that the mobile body passes; and
second point identification information for identifying a predetermined point on the second route, the first point identification information, the passing point identification information and the second point identification information being associated in an order in which the mobile body proceeds and constituting a single data structure.

17. A generating method of proceeding control information about a proceeding control at an intersection, the proceeding control being set over a mobile body proceeding from a first route to a second route via the intersection in which a plurality of routes intersect, the method comprising:
generating the proceeding control information including: first point identification information for identifying a predetermined point on the first route; passing point identification information for identifying the intersection; and second point identification information for identifying a predetermined point on the second route, the first point identification information, the passing point identification information and the second point identification information being associated with each other in a predetermined order and constituting a single data structure.

18. A generating method of proceeding control information showing a proceeding control on map information, the proceeding control being set over a mobile body proceeding from a first route to a second route via a predetermined point, the method comprising:
generating the proceeding control information including: first point identification information for identifying a predetermined point on the first route; passing point identification information for identifying the point the mobile body passes; and second point identification information for identifying a predetermined point on the second route, the first point identification information, the passing point identification information and the second point identification information being associated in an order in which the mobile body proceeds and constituting a single data structure.

19. A navigating device, comprising:
a current position information acquirer for acquiring current position information about a current position of a mobile body;
a destination information acquirer for acquiring destination information about a position of a destination to which the mobile body proceeds;
a route information acquirer for acquiring route information in which a route and an intersection are defined by a link and a node respectively;
a proceeding control information acquirer for acquiring proceeding control information about a proceeding control at an intersection, the proceeding control being set over a mobile body proceeding from a first route to a second route via the intersection in which a plurality of routes intersect; and
a route searcher for searching a travel route from the current position of the mobile body to the destination based on the current position information, the destination information, the route information and the proceeding control information, wherein
a data structure of the proceeding control information includes:
first point identification information for identifying a predetermined point on the first route;
passing point identification information for identifying the intersection; and
second point identification information for identifying a predetermined point on the second route, the first point identification information, the passing point identification information and the second point identification information being associated with each other in a predetermined order and constituting a single data structure.

20. A navigating device, comprising:
a current position information acquirer for acquiring current position information about a current position of a mobile body;
a destination information acquirer for acquiring destination information about a position of a destination to which the mobile body proceeds;
a route information acquirer for acquiring route information in which a route and an intersection are defined by a link and a node respectively;
a proceeding control information acquirer for acquiring proceeding control information showing a proceeding control on map information, the proceeding control being set over a mobile body proceeding from a first route to a second route via a predetermined point; and
a route searcher for searching a travel route from the current position of the mobile body to the destination based on the current position information, the destination information, the route information and the proceeding control information, wherein
a data structure of the proceeding control information includes:
first point identification information for identifying a predetermined point on the first route;
passing point identification information for identifying the point that the mobile body passes; and
second point identification information for identifying a predetermined point on the second route, the first point identification information, the passing point identification information and the second point identification information being associated in an order in which the mobile body proceeds and constituting a single data structure.
